(19) United States
(12) Patent Application Publication
(10) Pub. No.: US 2005/0047715 A1
(43) Pub. Date: Mar. 3, 2005

(54) Optical probe for wafer scale testing of light-electrical (l-i-v) performance of opto electronic devices

(76) Inventors: Yee Loy Lam, Singapore (SG); Yuen Chuen Chan, Singapore (SG); Lay Cheng Choo, Singapore (SG); Seng Lee Ng, Singapore (SG)

Correspondence Address: BUCKLEY, MASCHOFF, TALWALKAR LLC, 5 ELM STREET, NEW CANAAN, CT, 06840, US

(21) Appl. No.: 10/496,267

(22) PCT Filed: Nov. 18, 2002
(86) PCT No.: PCT/GB02/05191

(30) Foreign Application Priority Data
Nov. 19, 2001 (GB) 0127689.8

(51) Int. Cl. G02B 6/26

(52) U.S. Cl. 385/31; 385/49

(57) ABSTRACT

A method of testing an edge-emitting or edge-coupled opto-electronic device comprises the step of aligning an optical probe with an optical interface of the device so that light is coupled between the optical interface and the optical probe, wherein the optical probe comprises an optical fibre having a light turning structure at a distal tip that changes the direction of propagation of light incident on the light turning structure.

### BACKGROUND TO THE INVENTION

Optoelectronic devices, such as laser diodes, semiconductor optical amplifiers (SOAs), modulators and photodetectors, are fabricated on compound semiconductor wafers. In order to ensure sufficient interaction length between the light and the gain/absorption region of the material, waveguide technology to guide the light in the plane of the wafer is generally used. Construction of the waveguide is on the epi-layers, with the guiding layer sandwiched between the lower cladding and upper cladding layers, providing the vertical light guiding and confinement.

Lateral confinement of light is accomplished via ridge, rib or buried device construction. As such, light is coupled via the edge of such devices.

Edge emitting devices have many advantages. An obvious advantage includes the enhanced electrical-optical performance due to the longer interaction length compared to surface-emitting devices, such as vertical cavity surface emitting lasers. In addition, it also allows many devices to be integrated via wafer scale processing techniques, and this is the standard approach to integration in the industry.

Depending on the size of the device die, it is not uncommon for a fabricated wafer to comprise a large number of devices, ranging in the hundreds to the thousands. In the manufacturing process these dies would be eventually be separated and packaged into the individual modules. Amongst other production control considerations, such as for improved packaged yield and quality control, it is necessary to carry out testing and measurements of the devices at the various stages of fabrication and packaging.

Such testing should be sufficiently comprehensive to accurately ascertain if the device under test (DUT) is a good device or not. For an optoelectronic device, which is a device essentially providing either optical-electrical (O-E) or electrical-optical (E-O) functionality, it is usual practice to measure its light-electrical (L-I) transfer function, in addition to the electrical performance through current-voltage (I-V) measurements.

For edge-emitting or edge-coupled waveguide devices, the state of art of electrical-light probing requires testing at the die level. That is, the device is separated and then mounted on a heat-sink, after which electrical micro-precision probes are positioned on a respective probe-contact pad of the device. These pads are usually very small (in the order of micrometers), and microscope viewing and control of probe position is required. For coupling of light, it can be either carried out via free-space or through an optical fibre via the edge of the die. The waveguide is very small (with typical widths of a few micrometers) and hence very diverging as dictated by diffraction theory. Therefore, the required optics (free space objective lens or a fibre tip) has to be inserted within a very short distance (few micrometers) of the edge. In addition, the optical axis of the measuring optics has to be co-axial with the optical axis of the waveguide.

### SUMMARY OF THE INVENTION

According to a first aspect of the present invention, an optical probe comprises an optical fibre having a distal tip which incorporates a light turning structure that changes the direction of propagation of light incident on the light turning structure.

The present invention provides a probe that allows optical devices to be tested at the wafer level. The probe may be inserted substantially vertically into wells or deep trenches formed at the edges of the devices.

According to a second aspect of the present invention, a method of testing an edge-emitting or edge-coupled optoelectronic device comprises the step of aligning an optical probe with an optical interface of the device so that light is coupled between the optical interface and the optical probe, wherein the optical probe comprises an optical fibre having a light turning structure at a distal tip that changes the direction of propagation of light incident on the light turning structure.

Preferably, the optical probe is inserted substantially vertically into a well or a trench formed at the end of the device so that light is coupled generally transverse to its original direction of propagation.

Preferably, the distal tip of the optical fibre is chamfered to form a mirror surface that provides a light turning structure. More preferably, the distal tip is chamfered to provide a mirror surface at an angle of 45° to the optical axis of the optical fibre. However, other angles are possible depending on the preferred angle of insertion of the probe.

In a preferred example, the probe is used to couple light from an edge-emitting optical device, for example a laser, to a remote detector. However, the same probe can be used to couple light from a remote optical source into an edge-coupled optical device, for example a photodetector, under test.

Preferably, the cladding of the optical fibre in a region adjacent the distal tip of the fibre is narrowed. This has the effect of reducing the volume occupied by the distal tip, thereby making it easier to insert the probe into a given space adjacent the edge of the device under test.

The optical probe may be formed from a single-mode fibre. Alteratively, to provide spatial resolution, the probe may be formed from a fibre bundle.

In the present invention we propose a new L-I-V testing technique, whereby the measurement is done at wafer level for edge-emitting light sources, such as laser diodes and superluminescent diodes. By making possible wafer level probing, the light source devices can be tested in mass production volumes.

It is desired to have high testing throughput of the devices (hundreds to thousands per wafer). Hence, it is necessary to apply automation to the L-I-V testing. Automation is better to be done at wafer level rather than die level. For wafer level automation, devices can be handled and mounted all at one time i.e. individual devices do not need to be handled and mounted separately. Hence, wafer level handling of devices has the advantage of much shorter handling/mounting time. In addition, it is easier to handle at the wafer level. The exact location of the individual die is well defined at wafer level, as compared to the case when it is separated into die. This allows automation to be more easily applied, as it is possible to program the exact location of all the dies to be tested for computer control/automated testing.

Hence, wafer-scale L-I-V testing made possible by the present invention will bring benefits of faster, automated testing, lower handling damages and manpower savings. We only need to put the wafer on the precision stage and the computer and robot will do the remaining task of alignment and measurement.

### BRIEF DESCRIPTION OF THE DRAWINGS

Examples of the present invention will now be described in detail with reference to the accompanying drawings, in which:

FIG. 1A is a schematic perspective view of a light probing fibre and a semiconductor light source;

FIG. 1B is a side view of the light probing fibre of FIG. 1A;

FIG. 1C is a plan view of the light probing fibre of FIG. 1A;

FIG. 2 illustrates a deep well etched into a wafer to form facets that allow for the insertion of a light probing fibre in accordance with the present invention; and,

FIG. 3 shows different configurations of the light probing fibre.

### DETAILED DESCRIPTION

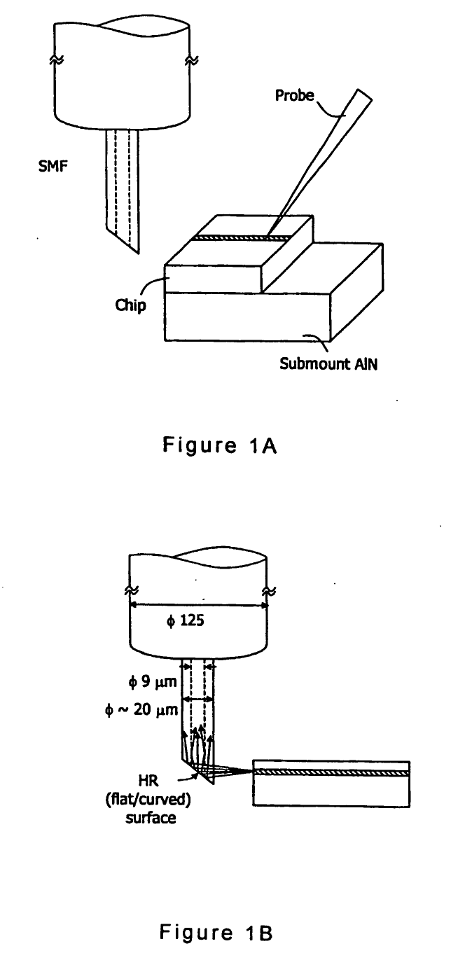

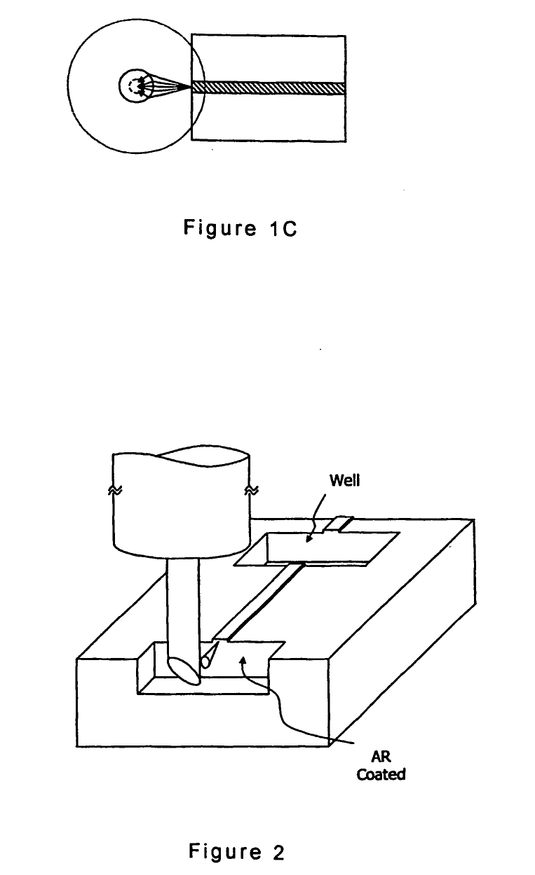

To probe laser diodes formed immediately after metallization and annealing, their mirror facets need to be formed through etching to define each device on the wafer. By introducing a deep facet etch, one is able to form the required cavity and to control the facet reflectivity through conformal coating of appropriate optical coatings. With such a deep trench, one is able to access the optical output from the facet by introducing a specially adapted optical fibre single mode fibre (SMF) into the trench as shown in FIGS. 1A to 1C and FIG. 2. In particular by chamfering the tip of an optical fibre to 45°, the light output can be directed upwards into the fibre.

As shown in the Figures, the optical fibre cladding can be suitably narrowed to a diameter of around 20 μm to allow for flexibility in light probing, especially in regions of limited space. In fact, light emitted in the lateral direction of the light source will converge towards the fibre core due to the lensing effect of the curved fibre cladding (see FIG. 1C). This light coupling can be enhanced by coating the chamfered tip with high reflection films, such as a metal, for example gold, to form a good light turning mirror. This configuration has a higher alignment tolerance between the fibre and light source since the light is collected over a wider area defined by the optical fibre cross-sectional area. The output of the fibre goes to a detecting and analysis device (not shown), such as a photodetector or an optical spectrum analyser (OSA), for spectrum determination.

As shown in FIG. 2, the optical output is accessed via a deep trench or pocket/well etched at the facet of the source. This deep trench or well is easily fabricated with dry etching to obtain the perpendicular sidewall. As an example, with a probe tip of 20 μm diameter, the minimum dimension of the well is in the range of 30 μm with a minimum depth in the range of 10˜15 μm. This trench or well fabrication step is also compatible with the additional step of depositing optical coatings onto the facets to obtain anti-reflection or high-reflection of the output light described in our co-pending British patent application number 0127690.6.

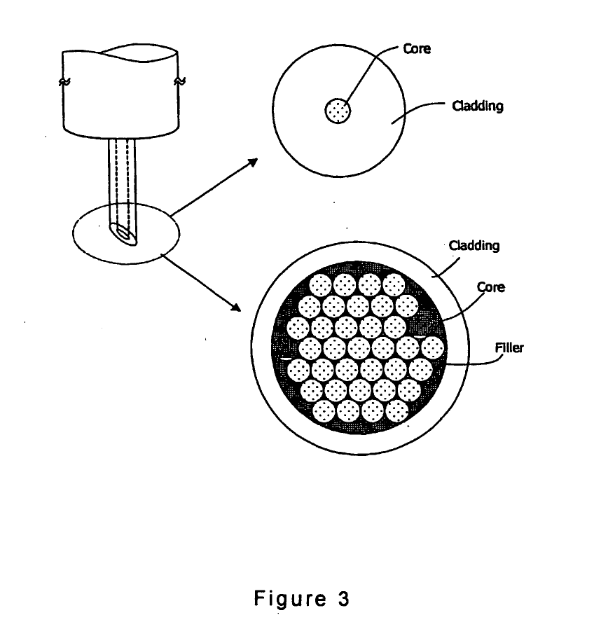

As shown in FIG. 3, besides the usage of an SMF as the light probe, a fibre bundle consisting of a number of fibres bundled and held together, can also be used. By imaging the output light at the other end of the fibre bundle onto a 2D photodetector array (not shown), it is possible to determine the spatial mode profile of the light emission.

In the present invention, we propose a novel way of performing wafer level L-I-V probing of edge emitting source devices via the introduction of a vertically aligned light probe into cavity-defining recess trench/well etched into the wafer. This technique allows for ease of coupling of light into the fibre, ease of handling of device under probe as the measurement is carried out at wafer level. This level of testing leads to a significant increase in the testing throughput and hence a reduction in the total production cost.

1. An optical probe comprising an optical fibre having a distal tip which incorporates a light turning structure that changes the direction of propagation of light incident on the light turning structure.

2. An optical probe according to claim 1, in which the distal tip of the optical fibre is chamfered to form a mirror surface that provides a light turning structure.

3. An optical probe according to claim 2, in which the distal tip is chamfered to provide a mirror surface at an angle of 45° to the optical axis of the optical fibre.

4. An optical probe according to claim 2, in which the mirror surface is coated with a high reflection film.

5. An optical probe according to claim 2, in which the cladding of the optical fibre in a region adjacent the distal tip of the fibre is narrowed.

6. An optical probe according to claim 2, in which the optical fibre is a single mode optical fibre.

7. An optical probe according to claim 2 comprising a bundle of optical fibres.

8. A method of testing an edge-emitting or edge-coupled opto-electronic device comprising the step of aligning an optical probe with an optical interface of the device so that light is coupled between the optical interface and the optical probe, wherein the optical probe comprises an optical fibre having a light turning structure at a distal tip that changes the direction of propagation of light incident on the light turning structure.

9. A method according to claim 8, in which the optical probe is inserted substantially vertically into a well or a trench formed at the end of the device so that light is coupled generally transverse to its original direction of propagation.

10. A method according to claim 8, in which a curved surface of the optical fibre acts a lens to light incident on it.

11. A method according to claim 8, in which light is coupled from the opto-electronic device to a remote sensor by means of the optical probe.

12. A method according to claim 8, in which light is coupled into the opto-electronic device from a remote source by means of the optical probe.

13. A method according to claim 8, in which spatial resolution is provided by an optical probe comprising a fibre bundle.
